(19) United States
(12) Patent Application Publication
(10) Pub. No.: US 2005/0214481 A1
(43) Pub. Date: Sep. 29, 2005

(54) Petals of ornamental artificial flower and production methods thereof

(75) Inventor: Patrick Tai, Hillsborough, CA (US)

Correspondence Address: Dorsey & Whitney LLP;Intellectual Property Department, Suite 3400, Four Embarcadero Center, San Francisco, CA, 94111-4187, US

(73) Assignee: Winward International, Inc., Union City, CA (US)

(21) Appl. No.: 11/089,866

(22) Filed: Mar. 25, 2005

(30) Foreign Application Priority Data
Mar. 29, 2004 (CN) 200410014514.9
Mar. 29, 2004 (CN) 200420025909.4

(51) Int. Cl. A41G 1/00; B29C 45/00; B29C 71/02

(52) U.S. Cl. 428/24; 264/328.15; 264/234; 264/129; 156/61

(57) ABSTRACT

A petal of an ornamental man-made flower and the production methods thereof is described. The flower patterns are directly printed on the plastic films which are delicate and smooth, thus making the printed patterns more lifelike. When the films are pasted to the base piece stratum of the petal, the patterns of the petal enjoy higher degree of vividness. And as such, the flowers produced in this method have better effects on a whole. The petal includes the base piece stratum of the petal, the upper and down surfaces of which are homologously covered and connected with the pasting piece stratum carrying the flower patterns of the upper surface of the petal and the pasting piece stratum carrying the flower patterns of the down surface of the petal. The process thereof includes the steps: process the base piece stratum of the petal, process the pasting piece stratus with the flower patterns, stick the pasting piece stratus with the flower patterns to the base piece stratum of the petal. In addition, an ornamental man-made flower is described. The plastic film has smooth texture and the patterns of the different parts of the flower printed on the plastic film get more vivid and similar to those of a real flower. When the plastic films are pasted to the corresponding parts of the man-made flower, the man-made flower enjoys higher degree of vividness. The flower includes twigs, on which there are leaves and dissilient flowers, featuring that the petal of the said dissilient flower includes a base piece stratum and the upper and down surfaces of the said base piece stratum are homologously covered and connected with one pasting piece stratum carrying the patterns of the upper surface of the petal and another pasting piece stratum carrying the patterns of the down surface of the petal.

### BACKGROUND OF THE INVENTION

1. Field of the Invention

This invention relates to an ornamental article and the production methods thereof, which are in particular the petals of an ornamental man-made flower and the production methods thereof. The invention also relates to a type of artware, in particular referring to an ornamental man-made flower

2. Description of Related Art

The petals of an existing higher-class ornamental man-made flower are most of them made of terylene cloth and the production methods usually include: 1) silk screen printing in which the flower patterns are directly printed with the halftone on the surface of cloth, and 2) movable printing in which you print the flower patterns on a piece of paper and then heat the piece of paper for pressing and print the patterns onto the cloth. As the surface of the cloth is not smooth enough and the depth of the paint permeated into the cloth is not even, the patterns printed in the above-mentioned two methods do not look lifelike and the second method will cause a great waste of paper. In order to avoid the said problems, the third method, namely dyeing, is adopted to punch a single-color cloth for the petals which are consequently placed in a dyejigger for direct dyeing before dehydrating, steaming, roasting and finally drawn in hand. Such process removes the unevenness of the depth of the paint permeated into the cloth, but the hand-drawn flower patterns can only show the flower's colors and patterns in a broad outline and are not as vivid as those produced by the aforesaid two methods that have a comparatively high speed and efficiency.

An often-seen ornamental man-made flower, on which twigs, leaves, dissilient flowers and bracts are distributed and dotted and the patterns of the different parts of which are mainly drawn by hand, can only show colors and patterns by and large and appears less vivid. As such, the patterns produced by means of printing come into being, such process can, however, be applied to the production of the flower leaves and petals with flatter structure, and moreover, because the flower leaves and petals are made of tyrylene cloth whose surface is not smooth enough and the depth of the paint permeated into the cloth is not even, the patterns printed in this method will be distorted and the distortion of the flowers will cause serious detrimental to the whole vividness of the flower.

### BRIEF SUMMARY OF THE INVENTION

In view of the insufficient vividness that has been found with the existing ornamental man-made flower's petals, this Invention creates an ornamental man-made flower's petals and the production methods thereof. The petals produced from this Invention have higher productivity and vividness in color and pattern as well as an entire flower made of such petals do when compared with a real one.

One aspect of the present invention is directed to a flower petal that has a base piece stratum and the upper and down surfaces of the said base piece stratum are homogonously covered and connected with one pasting piece stratum carrying the patterns of the upper surface of the petal and another pasting piece stratum carrying the patterns of the down surface of the petal.

It further features that a layer of all-lightless-face paint is coated respectively on the surfaces of the pasting piece stratus with the upper surface patterns and the down surface patterns of the said petal. A layer of protective film is respectively covered on the surfaces of the pasting piece stratus with the upper surface patterns and the down surface patterns of the said petal and on the outside of the said protective film is coated a layer of all-lightless-face paint. The pasting piece stratum with the upper surface patterns of the said petal includes one plastic film, on the surface of which are printed the upper surface patterns of the said petal. The pasting piece stratum with the down surface patterns of the said petal includes another plastic film, on the surface of which are printed the down surface patterns of the said petal.

One production method for the petal of an ornamental man-made flower includes the following steps:
a. Process the base piece stratum of the petal;
b. Process the pasting piece stratus with the flower patterns;
c. Affix the pasting piece stratus with the flower patterns onto the base piece stratum of the petal.

It further features that Step a, process the base piece stratum of the petal, may be illustrated as follows: put PVC into the material pipe of an extruder and heat it to 180-220° and close the molds of the extruder upon its being dissolved for extruding and injecting and at last, open the molds. The period between closing and opening the molds lasts 37-43 seconds. Step a may also be conducted this way: put polythene into the material pipe of an injector and heat it to 180-220° and close the molds of the injector upon its being dissolved and then inject it, at last open the molds. The period between closing and opening the molds lasts 10-15 seconds.

Another production method for the petals of an ornamental man-made flower consists of the following steps:
d. Process the base piece stratum of the petal—Cut a piece of plastic cloth made of EVA into the base piece stratum of the petal according to the required size.
e. Process the pasting piece stratus with the flower patterns;
f. Affix the pasting piece stratus with the flower patterns onto the base piece stratum;
g. Put the petals affixed with the pasting piece stratus carrying the flower patterns into the mold made of aluminum and place the mold in a steamer for steaming and shaping at a temperature of 100°-140°.

The third production method for the petal of an ornamental man-made flower includes the following steps:
h. Process the base piece stratum of the petal—Directly punch a piece of single-color cloth into the base piece stratum of a petal by using a punch.
i. Process the pasting piece stratus with the flower patterns;
j. Put the base piece stratum of the petal made of cloth on a shaper for shaping through heating and pressing at a temperature of 130°-150°;
k. Affix the pasting piece stratus onto the base piece stratum of the petal.

It further features that among the above-mentioned three methods, processing the pasting piece stratus with the flower patterns means a layer of gluewater will be firstly painted on the surface of the paper carrier and paste the plastic film onto the paper carrier. Secondly, print the patterns on the plastic film outside inward. After the paint turns dry, a layer of gluewater will be painted on the side with the patterns and a piece of covering paper will be stuck to the side. When sticking the pasting piece stratus to the base piece stratum of the petal, the covering paper will be torn from the surfaces of the pasting piece stratus which will then be stuck to the base piece stratum of the petal and the flower patterns on the upper and down surfaces of the petal will be respectively homologous to the upper and down surfaces of the base piece stratum of the said petal. The paper carrier can then be torn from the pasting piece stratus with the flower patterns. A layer of protective film will be painted on the surface of the produced petal and a layer all-lightless-face paint will be coated on the face of the protective film upon its being dried. A layer of all-lightless-face paint may be directly coated on the surface of the produced petal. The production method for the said protective film includes the following steps: intermingle even No. 5842 gluewater, wheat flour, farina, acetone, ferment and alcohol with different components at a weight proportion of: No. 5842 gluewater 94-98 units, wheat flour 38-42 units, farina 4.6-5 units, acetone 1.3-1.7 units, ferment 238-242 units and alcohol 98-102 units.

The above process is adopted in this Invention and the flower patterns are directly printed on the plastic film which is delicate and smooth, thus making the printed patterns more lifelike. When the film is pasted to the base piece stratum of the petal, the patterns of the petal enjoy higher degree of vividness. And as such, the whole flower produced this way appears more vivid.

As noted above, the patterns of the different parts of the existing ornamental man-made flower are insufficient in vividness and the distortion of flowers will cause serious detrimental to the degree of vividness of the whole flower. In view of such defects, this invention also offers another type of ornamental man-made flower that enjoys higher degree of vividness.

Another aspect of the present invention is directed to a flower that includes twigs, on which there are leaves and dissilient flowers, featuring that the petal of the said dissilient flower includes a base piece stratum, the upper and down surfaces of the said base piece stratum are homologously covered and connected with one pasting piece stratum carrying the patterns of the upper surface of the petal and another pasting piece stratum carrying the patterns of the down surface of the petal.

It further features that on the surface of the petal affixed with the pasting piece stratus carrying the patterns are coated protective films, on the outside of which are coated all-lightless-face paint; on the surface of the petal affixed with the pasting piece stratus carrying the patterns is coated all-lightless-face paint; the base piece stratum of the said petal is made of PVC plastics; the base piece stratum of the said petal is made of EVA plastics; the said flower leaf includes its base piece stratum, the upper and down surfaces of the said base piece stratum are homologously covered and connected with one pasting piece stratum carrying the patterns of the upper surface of the flower leaf and another pasting piece stratum carrying the patterns of the down surface of the flower leaf; the base piece stratum of the said flower leaf is made of PE plastics; the base piece stratum of the said flower leaf is made of cloth; the said flower twig includes a basal stratum and on the surface of the basal stratum is stuck the pasting piece stratus with the patterns of the flower twigs; the basal stratum of the said twig is made of PE plastics; Around the said flower twigs are distributed and dotted bracts and the said bract includes the basal stratum of the bract, on the surface of the basal stratum of the said bract is stuck the pasting piece stratum with the bract patterns; the basal stratum of the said bract is made of polystyrene foam plastics; the basal stratum of the said bract is made of EVA plastics; the basal stratum of the said bract is made of cloth; the said pasting piece stratum includes a layer of plastic film, on the surface of which is printed the patterns.

Whereas the above mentioned structure is adopted and the plastic film has smooth texture and the patterns of the different parts of the flower printed on the plastic film get more vivid and similar to those of the real flower and the plastic films are pasted on the corresponding parts of the man-made flower, the present invention improves much in the degree of vividness on a whole.

The petals of ornamental artificial flower and production methods thereof of the present invention has other features and advantages which will be apparent from or are set forth in more detail in the accompanying drawings, which are incorporated in and form a part of this specification, and the following Detailed Description of the Invention, which together serve to explain the principles of the present invention.

### BRIEF DESCRIPTION OF THE DRAWINGS

FIG. 1 is schematic view of a flower.

FIG. 2 is an enlarged cross-sectional view of the flower of FIG. 1 taken along line A-A of FIG. 1.

FIG. 3 is a schematic view of the structure of a flower.

FIG. 4 is an enlarged cross-sectional view of the flower of FIG. 3 taken along line B-B of FIG. 3.

FIG. 5 is an enlarged cross-sectional view of the flower of FIG. 3 taken along line C-C of FIG. 3.

FIG. 6 is an enlarged cross-sectional view of the flower of FIG. 3 taken along line E-E of FIG. 3.

FIG. 7 is an enlarged cross-sectional view of the flower of FIG. 3 taken along line D-D of FIG. 3.

### DETAILED DESCRIPTION OF THE INVENTION

Reference will now be made in detail to the preferred embodiments of the invention, examples of which are illustrated in the accompanying drawings. While the invention will be described in conjunction with the preferred embodiments, it will be understood that they are not intended to limit the invention to those embodiments. On the contrary, the invention is intended to cover alternatives, modifications and equivalents, which may be included within the spirit and scope of the invention as defined by the appended claims.

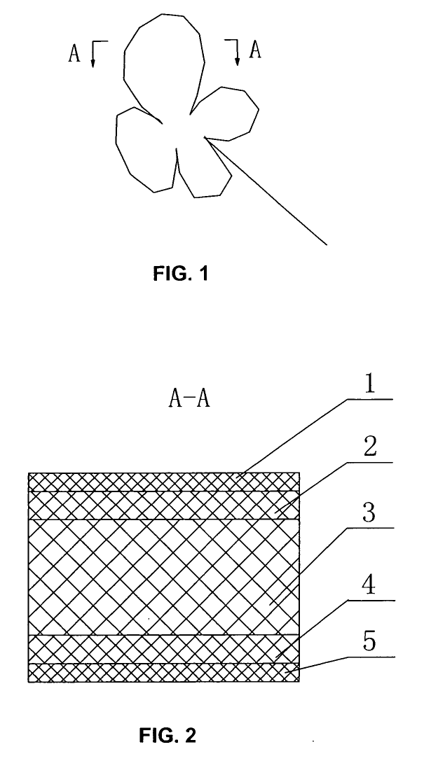

As shown in FIG. 1 and FIG. 2, the petal of an ornamental man-made flower includes: the base piece stratum 3, the upper and down surfaces of the base piece stratum are homologously covered and connected with one pasting piece stratum 2 carrying the upper surface patterns of the petal and another pasting piece stratum 4 carrying the down surface patterns of the petal, and there are protective films 1 and 5 respectively on the pasting piece stratum 2 with the upper surface patterns of the petal and the pasting piece stratum 4 with the down surface patterns of the petal. The protective films 1 and 5 are coated all-lightless-face paint on the outside, or all-lightless-face paint is directly coated on the surface of the pasting piece stratum 2 with the upper surface patterns of the petal and the pasting piece stratum 4 with the down surface patterns of the petal. The pasting piece stratum 2 with the upper surface patterns of the petal includes a plastic film, on the surface of which the upper surface patterns of the petal are printed. The pasting piece stratum 4 with the down surface patterns of the petal includes a plastic film, on the surface of which the down surface patterns of the petal are printed.

One will appreciate that the all-lightless-face paint of the present invention may be a mat finish paint which provides a lifelike simulation of a flower. Alternatively, the all-lightless-face paint of the present invention may comprise a flexible translucent transfer image that is applied to the base stratum.

A further description of the production method for the petal of an ornamental man-made flower is given below together with some practical cases:

Case 1

a. Process the base piece stratum of the petal—Put PVC into the material pipe of an extruder and heat it to 180-220°, better to 200°. Close the molds of the injector upon PVC being dissolved and inject it, finally open the molds. The period between closing and opening the molds lasts 37-43 seconds, better 40 seconds. Or in alternative way, put polythene into the material pipe of an injector and heat it to 180°-220°, better to 200° and close the molds of the injector upon its being dissolved and then inject it, at last open the molds. The period between closing and opening the molds lasts 10-15 seconds, better 12 seconds;

b. Process the pasting piece stratus with the flower patterns;

c. Stick the pasting piece stratus with the flower patterns to the base piece stratum of the petal.

Where necessary, following step c, a layer of all-lightless-face paint may be coated on the surface of the petal; or coat a protective film on the surface of the petal and coat all-lightless-face paint on the surface of the protective film upon its being dried.

Case 2

d. Process the base piece stratum of the petal—Cut a piece of plastic cloth of EVA into the base piece stratum of the petal according to the required size;

e. Process the pasting piece stratus with the flower patterns;

f. Stick the pasting piece stratus with the flower patterns to the base piece stratum;

g. Put the petals affixed with the pasting piece stratus carrying the flower patterns in a mold made of aluminum and place it in a steamer for steaming and shaping at a temperature of 100°-140°, better 110°.

Where necessary, following step g, a layer of all-lightless-face paint may be coated on the surface of the petal; or coat a protective film on the surface of the petal and coat all-lightless-face paint on the surface of the protective film upon its being dried.

Case 3

h. Process the base piece stratum of the petal—Directly punch a piece of single-color cloth into the base piece stratum of a petal by using a punch;

i. Process the pasting piece stratus with the flower patterns;

j. Put the base piece stratum of the petal made of cloth on a shaper for shaping through heating and pressing at a temperature of 130°-150°, better at 140°.

k. Stick the pasting piece stratus to the base piece stratum of the petal.

Where necessary, following step k, a layer of all-lightless-face paint may be coated on the surface of the petal; or coat a protective film on the surface of the petal and coat all-lightless-face paint on the surface of the protective film upon its being dried.

All-lightless-face paint No. 3099Y used in this Invention is manufactured by Guangdong Gaoming Jinhui Chemical Ink Co., LTD.

The production method for the pasting piece stratus is common in the above three practical cases, namely, at first, paint a layer of gluewater (common Jiang Hu is also available here) on the paper carrier and paste a plastic film on the paper carrier (the plastic film here is made of polythene and the technology for producing plastic film is general). Secondly, print the patterns on the surface of the plastic film outside inward. When the paint turns dry, a layer of sticky gluewater (the gluewater here may be Arab balata, the main components of which are resin) will be painted on the surface of the plastic film with the patterns. At last, paste a level of covering paper on the upper surface of the plastic film. The paper carrier is made of Shandong Sunlight paper, 157 g hectograph and the covering paper is made of silicon paper manufactured by Zhejiang Cangnan Huasheng Co., LTD. Sticking the pasting piece stratus with the flower patterns to the base piece stratum of the petal is conducted as follows: Firstly tear the covering paper from the surface of the pasting piece stratus and stick the pasting piece stratus to the base piece stratum with the flower patterns on the upper and down surfaces of the petal corresponding to the two surfaces of the base piece stratum; then tear the paper carrier from the surface of the pasting piece stratus with the flower patterns. The production method for the said protective film includes the following step: intermingle even No. 5842 gluewater, wheat flour, farina, acetone, ferment and alcohol with different components at a weight proportion of: No. 5842 gluewater 94-98 units, better 96 units; wheat flour 38-42 units, better 40 units; farina 4.6-5 units, better 4.8 units; acetone 1.3-1.7 units, better 1.5 units; ferment 238-242 units, better 240 units; alcohol 98-102 units, better 100 units.

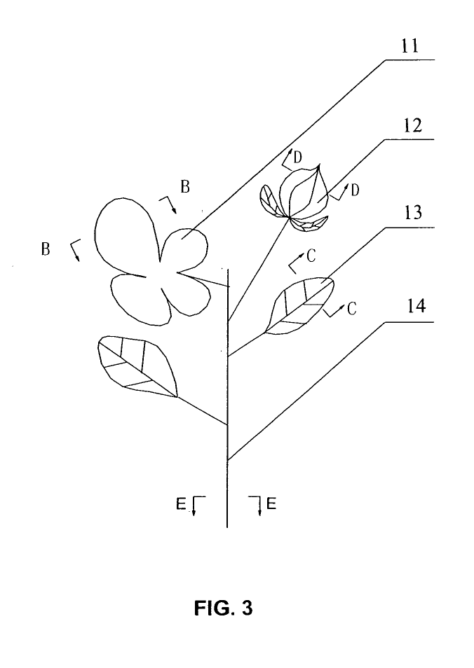

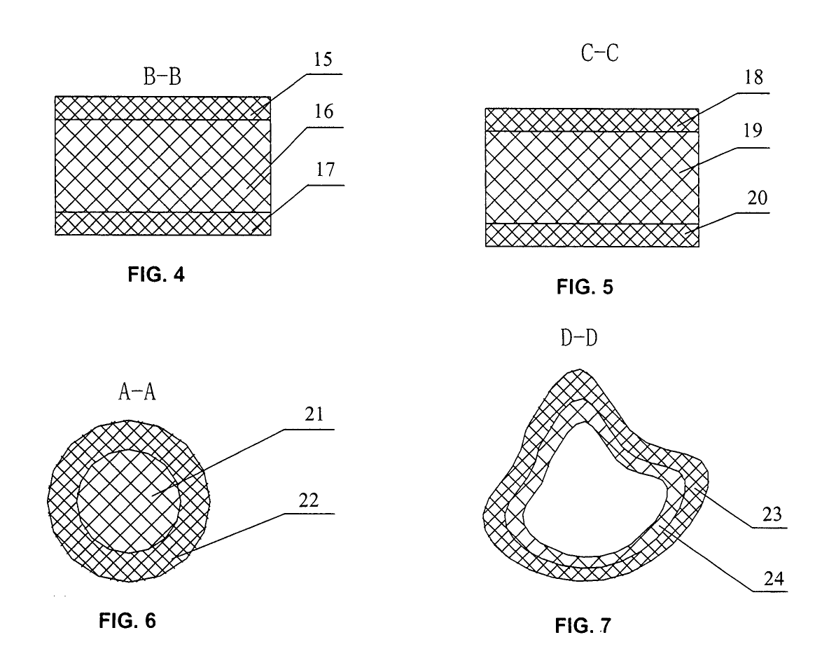

Turning now to FIG. 3, in one embodiment, this invention includes the flower twigs 14, on which there are flower leaves 13 and dissilient flowers 11. As shown in FIG. 4, the petal of the dissilient flower 11 includes a base piece stratum 16 of the petal, the upper and down surfaces of the base piece stratum 16 are homologously covered and connected with one pasting piece stratum 15 carrying the patterns of the upper surface of the petal and another pasting piece stratum 17 carrying the patterns of the down surface of the petal; on the outside of the pasting piece stratus 15 and 17 are coated protective films, on the outside of which is coated all-lightless-face paint, or on the outside of the pasting piece stratus 15 and 17 is directly coated all-lightless-face paint; the layer of protective film and all-lightless-face paint are not indicated in FIG. 4. The production method for the protective film includes the following steps: intermingle even No. 5842 gluewater, wheat flour, farina, acetone, ferment and alcohol with different components at a weight proportion of: No. 5842 gluewater 94-98 units, wheat flour 38-42 units, farina 4.6-5 units, acetone 1.3-1.7 units, ferment 238-242 units and alcohol 98-102 units. All-lightless-face paint No. 3099Y used herein is manufactured by Guangdong Gaoming Jinhui Chemical Ink Co., LTD. The base piece stratum can be made of PVC plastics (also called polyvinyl chloride), EVA plastics or PE plastics (also called polythene) or cloth. As shown in FIG. 5, the flower leaf 13 includes the base piece stratum 19 of the flower leaf, the upper and down surfaces of the base piece stratum 19 are homologously covered and connected with one pasting piece stratum 18 carrying the patterns of the upper surface of the flower leaf and another pasting piece stratum 20 carrying the patterns of the down surface of the flower leaf and the base piece stratum is made of PE plastics or cloth. In FIG. 6, the flower twig 14 includes the basal stratum 21 of the flower twig, on the surface of which is stuck the pasting piece stratum with the patterns of the flower twig; the basal stratum of the flower twig is made of PE plastics. Around the flower twig are distributed and dotted the flower bracts 12. As shown in FIG. 7, the bract 12 includes the basal stratum 24 of the bract, on the surface of which is affixed the pasting piece stratus 23 with the patterns of the bract. The basal stratum of the bract is made of polystyrene foam plastics or cloth. In order to clearly show the structure of the different parts of this invention, FIG. 4, FIG. 5, FIG. 6 and FIG. 6 are disproportionate to the corresponding parts of FIG. 3. When making the petals, flower leaves and bracts of cloth, the corresponding shapes may be punched into by a punch; when making flower twigs, leaves, petals of PE plastics, it may be directly injected through an injector; when making the petals of EVA plastics and bracts of EVA plastics, polystyrene foam plastics, the corresponding plastic granules can all be put in a petal or bract mold made of aluminum which is then placed in a steamer for steaming and frothing; when making the petals of PVC plastics, it may be directly extruded and injected through an extruder. The pasting piece stratus 15, 17, 18, 20, 22, 23 respectively include a layer of plastic film, on the surface of which are printed the patterns; stick the corresponding pasting piece stratus to the base piece stratus of the corresponding parts of this invention and at last, link the petals with the pistils and toruses into a flower and connect the flowers and flower leaves, bracts onto the flower twigs through pasting or heating and pressing. The connection process belongs to the existing technology and this invention is so accomplished.

One aspect of this embodiment is directed to an ornamental man-made flower including the twig, on which there are flower leaves and dissilient flowers. It features the said dissilient flower, of which the petal includes a base piece stratum. The upper and down surfaces of the said base piece stratum are homologously covered and connected with one pasting piece stratum carrying the patterns of the upper surface of the petal and another pasting piece stratum carrying the patterns of the down surface of the petal.

The flower may feature the petal affixed with the pasting piece stratus, on the surface of the petal are painted protective films; on the outside of the protective film is coated all-lightless-face paint.

The flower may feature that there is all-lightless-face paint on the surface of the petal affixed with pasting piece stratus.

The flower may feature the base piece stratum of the said petal is made of PVC plastics.

The flower may feature the base piece stratum of the said petal is made of EVA plastics.

The flower may feature the base piece stratum of the said petal is made of cloth.

The flower may feature the base piece stratum of the said petal is made of PE plastics.

The flower may feature the said flower leaf includes the leaf's base piece stratum, the upper and down surfaces of the said base piece stratum are homologously covered and connected with one pasting piece stratum carrying the patterns of the leaf's upper surface and another pasting piece stratum carrying the patterns of the leaf's down surface.

The flower may feature the base piece stratum of the said flower leaf is made of PE plastics.

The flower may feature the base piece stratum of the said flower leaf is made of cloth.

The flower may feature the said flower twig includes the twig's basal stratum; the surface of the said twig's basal stratum is affixed with the pasting piece stratus carrying the twig's patterns.

The flower may feature the said flower twig's basal stratum is made of PE plastics.

The flower may feature that around the said flower twig are distributed and dotted the flower bracts and the said bract includes a basal stratum, on the surface of which is affixed the pasting piece stratum carrying the bract's patterns.

The flower may feature the basal stratum of the said flower bract is made of polystyrene foam plastics.

The flower may feature the basal stratum of the said flower bract is made of EVA plastics. The flower may feature the basal stratum of the said flower bract is made of cloth.

The flower may feature that the said pasting piece stratum includes a layer of plastic film, on the surface of which is printed the patterns.

Preferably, the molded flower portion is formed from a translucent polyvinyl chloride, however, one will appreciate that other suitable materials, including other suitable translucent materials, may be used in accordance with the present invention. The use of PVC provides for an artificial flower with a feel that is more lifelike than conventional artificial flowers. The translucent nature of the molded flower also makes the molded flower appear more lifelike.

One will appreciate that pasting piece stratum 2 and pasting piece stratum 4 may be in the form of a flexible transfer image which is disposed on a transfer medium in a conventional manner and applied to the molded flower portion or base piece stratum 3. The transfer images are color images of the artificial flower portion and adds color to the molded flower portion to mimic the physical appearance of a natural flower. The transfer image may include one, two, three, four or more colors. Preferably, the transfer image is a translucent image. Such translucent configuration may complement the translucent or semi-translucent PVC flower portion to provide for an artificial flower that is more lifelike.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

1. A petal of an ornamental man-made flower comprising:
a base piece stratum of the petal; and
upper and lower surfaces of the said base piece stratum are covered and connected homologously with one pasting piece stratum carrying the flower patterns of the upper surface of the petal and another pasting piece stratum carrying the flower patterns of the down surface of the petal.

2. The petal of an ornamental man-made flower of claim 1, wherein on the surfaces of the pasting piece stratum with the flower patterns of the upper surface of the said petal and the pasting piece stratum with the flower patterns of the down surface of the same petal is respectively coated a layer of all-lightless-face paint.

3. The petal of an ornamental man-made flower stated in claim 1, wherein the surfaces of the pasting piece stratum with the flower patterns of the upper surface of the said petal and the pasting piece stratum with the flower patterns of the down surface of the same petal are respectively covered with a protective film, on the outside surface of the said protective film is coated a layer of all-lightless-face paint.

4. The petal of an ornamental man-made flower of claim 1, wherein the pasting piece stratum with the flower patterns of the upper surface of the said petal includes a layer of plastic film, on the surface of which are printed the patterns of the upper surface of the same petal.

5. The petal of an ornamental man-made flower of claim 1, wherein the pasting piece stratum with the flower patterns of the down surface of the said petal includes a layer of plastic film, on the surface of which are printed the patterns of the down surface of the same petal.

6. A method for producing the petal of the ornamental man-made flower of claim 1, said method comprising the steps:
a. process the base piece stratum of the petal;
b. process the pasting piece stratus with the flower patterns;
c. stick the pasting piece stratus with the flower patterns to the base piece stratum of the petal.

7. The method for the petal of an ornamental man-made flower of claim 6, wherein the method for the said step a, namely, process the base piece stratum of the petal, is to put PVC into the material pipe of an extruder and heat it to 180-220°, close the molds of the extruder upon its being dissolved for extruding and injecting and at last, open the molds, wherein the period between closing and opening the molds is 37-43 seconds.

8. The method for the petal of an ornamental man-made flower of claim 6, wherein the method for the said step a, namely, process the base piece stratum of the petal, is to put polythene into the material pipe of an injector and heat it to 180-220°, close the molds of the injector for injecting upon its being dissolved and at last open the molds, wherein the period between closing and opening the molds is 10-15 seconds.

9. A method for producing the petal of the ornamental man-made flower of claim 1, said method comprising the steps:
d. process the base piece stratum of the petal, cut a piece of plastic cloth made of EVA into the base piece stratum of the petal according to the required size;
e. process the pasting piece stratus with the flower patterns;
f. stick the pasting piece stratus with the flower patterns to the base piece stratum;
g. put the petals affixed with the pasting piece stratus carrying the flower patterns into the mold made of aluminum and place the mold in a steamer for steaming and shaping at a temperature of 100°-140°.

10. A method for producing the petal of the ornamental man-made flower of claim 1, said method comprising the steps:
h. process the base piece stratum of the petal, directly punch a piece of single-color cloth into the base piece stratus of the petals by using a punch;
i. process the pasting piece stratus with the flower patterns;
j. place the base piece stratus of the petals made of cloth on a shaper for shaping through heating and pressing at a temperature of 130°-150°;
k. stick the pasting piece stratus to the base piece stratum of the petal.

11. The method for producing the petal of the ornamental man-made flower of claim 6, wherein the pasting piece stratus step is accomplished by firstly painting a layer of gluewater on the surface of the piece of paper carrier and paste a layer of plastic film on the piece of paper carrier, secondly painting the patterns on the layer of plastic film outside inward, wherein when the paint turns dry, coating a layer of gluewater on the face with the patterns before pasting a layer of covering paper.

12. The method for producing the petal of the ornamental man-made flower of claim 6, wherein the stick the pasting piece stratus step is accomplished by tearing the layer of covering paper from the upper surfaces of the pasting piece stratus with the flower patterns and sticking the pasting piece stratus to the base piece stratum of the petal, wherein the flower patterns of the upper and down surfaces of the petal are homologous to the upper and down surfaces of the said base piece stratum of the petal, and then tearing the layer of paper carrier from the pasting piece stratus with the flower patterns.

13. The method for producing the petal of the ornamental man-made flower of claim 6, further comprising painting a layer of protective film on the surface of the produced petal and coating a layer of all-lightless-face paint on the surface of the protective film upon its being dried.

14. The method for producing the petal of the ornamental man-made flower of claim 6, further comprising coating a layer of all-lightless-face paint on the surface of the produced petal.

15. The method for producing the petal of the ornamental man-made flower of claim 13, further comprising the steps: intermingle even No. 5842 gluewater, wheat flour, farina, acetone, ferment and alcohol with different components at a weight proportion of: No. 5842 gluewater 94-98 units, wheat flour 38-42 units, farina 4.6-5 units, acetone 1.3-1.7 units, ferment 238-242 units and alcohol 98-102 units.

16. An artificial flower comprising:
a translucent molded flower portion formed from a polyvinyl chloride (PVC); and
a flexible translucent transfer image disposed on the molded flower portion.

17. The artificial flower of claim 16, further comprising a simulated stem, and a plurality of translucent simulated flower petals, each being formed of PVC, and having disposed on the PVC petals a flexible translucent transfer image.

18. The artificial flower of claim 16, further comprising a protective coating disposed over the transfer image.

19. The artificial flower of claim 18, wherein the simulated flower petal is molded to have a plurality of contours, and wherein the transfer image adheres to the contours.

20. The artificial flower of claim 19, wherein the molded flower portion is a simulated flower petal.
